(19) United States
(12) Patent Application Publication
(10) Pub. No.: US 2011/0066380 A1
(43) Pub. Date: Mar. 17, 2011

(54) SUBSURFACE RESERVOIR ANALYSIS BASED ON FLUID INJECTION

(75) Inventors: Bradford Hager, Concord, MA (US); Charles Franklin Harvey, Concord, MA (US); Kurt Zenz House, Cambridge, MA (US)

(73) Assignee: C12 Energy Inc., Berkeley, CA (US)

(21) Appl. No.: 12/879,695

(22) Filed: Sep. 10, 2010

Related U.S. Application Data
(60) Provisional application No. 61/241,504, filed on Sep. 11, 2009.

(51) Int. Cl. G01V 5/04; E21B 49/00

(52) U.S. Cl. 702/8; 702/12

(57) ABSTRACT

A subsurface reservoir may be characterized and/or monitored based on fluid injection. For example, fluid may be injected into the reservoir, and data (e.g., seismic data, geodetic data, pressure data) relating to the injected fluid in the reservoir may be used to identify characteristics of the reservoir and/or to monitor the injected fluid in the reservoir. In some aspects, air or another type of surrogate fluid is injected into the reservoir, and the reservoir's viability as a carbon dioxide sequestration site can be analyzed based on response data collected from the reservoir. In some aspects, carbon dioxide is sequestered in the subsurface reservoir, and three-dimensional geodetic response data is collected and used to monitor and/or facilitate quality control.

### CROSS-REFERENCE TO RELATED APPLICATIONS

This application claims priority to U.S. Provisional Application Ser. No. 61/241,504, entitled “A Process for the Characterization of Geologic Formations for Carbon Dioxide Sequestration by Combining an Air Injection with Geodetic Measurements and Seismic Imagery,” filed on Sep. 11, 2009, the entire contents of which is hereby incorporated by reference for all purposes.

### BACKGROUND

The present disclosure relates to analysis of subsurface reservoirs for fluid (e.g., liquid, gas, supercritical fluid) sequestration. Geologic formations such as oil and gas reservoirs, coal seams, and saline reservoirs have been proposed as a storage medium for intermediate-term storage and long-term sequestration of carbon dioxide, natural gas, and other types of fluids. For example, in some cases, carbon dioxide is captured and injected through a well bore into a porous reservoir in the subsurface formation. The porous reservoir may reside in the subsurface formation beneath an impermeable cap rock layer that prevents the carbon dioxide from escaping the reservoir. The formation's ability to effectively store the carbon dioxide gas depends on many factors, including the size of the reservoir, the permeability and conductivity of the reservoir rock, the existence of fractures and leakage pathways in the formation, and possibly other factors. The existence of faults, fractures, or leaks in the cap rock may compromise the reservoir's viability as a sequestration site. Increased pore-pressures induced by injection may open existing fractures, activate existing faults, or create new faults or fractures. Such injection-induced faulting or fracturing could produce seismicity and potentially create new leakage pathways.

### SUMMARY

In a general aspect, a subsurface reservoir may be analyzed based on fluid injection. Identifying the presence of faults, fractures, leakage pathways and reservoir weaknesses is of great value in determining a reservoir's suitability for fluid storage or sequestration. In some implementations, such properties may be identified and/or analyzed based on the injection of air and/or other fluids into the reservoir. In some implementations, such properties may be identified and/or analyzed based on three-dimensional geodetic data and/or other types of data.

In some cases, the injected fluid includes carbon dioxide. For example, in cases where a reservoir is being used for carbon dioxide sequestration, data collected before, during and/or after the injection of carbon dioxide may be used to monitor the sequestration process. In some implementations, the injected fluid is a surrogate fluid. For example, in cases where the reservoir is a candidate site for carbon dioxide sequestration, data collected before, during and/or after the injection of the surrogate fluid may be used to determine the reservoir's viability as a carbon dioxide sequestration site. In addition to characterizing and/or monitoring carbon dioxide sequestration sites, the disclosed techniques may be used in an analogous manner to characterize and/or monitor sequestration sites for other types of fluid.

The techniques described herein may be used, in some implementations, to characterize subsurface reservoir attributes that are relevant to the reservoir's usefulness and viability as a fluid sequestration and/or storage site. The described techniques may utilize relatively inexpensive compressed air, flue gas, and/or other types of fluids for characterizing the reservoir. Data may be collected by satellite and/or airborne imagery, ground GPS data, seismic data, and/or other types of data collection systems.

In one aspect, a test fluid is injected into a reservoir in a subsurface region. The test fluid is either less dense than carbon dioxide, less viscous than carbon dioxide, or both. Response data associated with the test fluid in the reservoir is collected, and the reservoir's suitability for carbon dioxide sequestration is determined based on the response data.

Implementations may include one or more of the following features. The test fluid includes air, flue gas, and/or another type of gas. The response data includes seismic data, geodetic data, or both. Seismic data includes two-dimensional and/or three-dimensional seismic data collected at sensors above the subsurface region. Seismic data includes vertical seismic profile data collected at sensors in the subsurface region. The seismic data can be used to monitor injection-induced seismicity, to characterize induced faulting or fracturing, and/or to generate seismic imagery of the test fluid in the reservoir.

Geodetic data is collected using GPS receivers above the subsurface region, satellite InSAR, aerial InSAR, tilt meters, leveling instruments, and/or laser ranging instruments. The geodetic data can be used to determine the locations, and/or changes in the locations, of points on the surface above the subsurface region.

In another aspect, a surrogate fluid is injected into a reservoir in a subsurface region. Response data associated with the surrogate fluid in the reservoir is collected. One or more characteristics of the reservoir are determined based on the response data. A suitability of the reservoir for sequestration of a fluid for storage is determined based on the characteristic(s).

Implementations may include one or more of the following features. The fluid for storage is a gas to be stored in the reservoir, such as carbon dioxide, natural gas, or another fluid. The surrogate fluid can contain substantially none of the fluid for storage. The surrogate fluid includes brine water, air, other fluids, combinations of these, mixtures of fluids injected together and/or a series of different fluids injected at different times. The response data includes geodetic surface data. A movement of a surface above the reservoir is identified based on the geodetic surface data, and the characteristic(s) of the reservoir are determined based on the movement of the surface and/or deformation of the surface. The response data includes seismic imagery data of the surrogate fluid in the reservoir. Movement of the surrogate fluid in the subsurface region is identified based on seismic imagery data and/or geodetic data. The characteristic(s) of the reservoir are determined based on the movement of the surrogate fluid and/or deformation of the surface. The characteristic(s) include hydrogeologic properties of the reservoir, geomechanical properties of the reservoir, both of them, and/or other types of properties. Example hydrogeologic properties include permeability of the reservoir and/or a conductivity field of the reservoir. Example geomechanical properties include fractures in the reservoir, boundaries of the reservoir, compressibility, state of stress, mechanical properties, and/or others.

In another aspect, fluid is injected into a reservoir in a subsurface region. Three-dimensional geodetic data associated with a surface above the subsurface region is collected. A three-dimensional geodetic response to the fluid in the reservoir is identified based on the three-dimensional geodetic data. One or more characteristic(s) of the reservoir are identified based on the three-dimensional geodetic response.

Implementations may include one or more of the following features. The three-dimensional geodetic data is collected using GPS receivers above the subsurface region, satellite InSAR, aerial InSAR, tilt meters, leveling instruments, and/or laser ranging instruments. The three-dimensional geodetic response includes a deformation of the surface, and the characteristic(s) are determined based on the deformation. The three-dimensional geodetic data indicates movement of points on the surface, including movement tangential to and/or perpendicular to the surface. The characteristic(s) include a location of the injected fluid in the reservoir. The fluid includes carbon dioxide, a test fluid, a surrogate fluid, or combinations of them. A suitability of the reservoir for carbon dioxide sequestration may be determined prior to injecting carbon dioxide into the reservoir. The characteristic(s) may be monitored while injecting carbon dioxide into the reservoir and/or after injecting carbon dioxide into the reservoir.

The details of one or more embodiments are set forth in the accompanying drawings and the description below. Other features, objects, and advantages will be apparent from the description and drawings, and from the claims.

### DESCRIPTION OF DRAWINGS

FIG. 1A is a diagram showing aspects of an example reservoir system.

FIG. 1B is a diagram showing additional aspects of the example reservoir system 100 of FIG. 1A.

FIG. 1C is a diagram showing example locations of GPS receivers in the example reservoir system 100 of FIG. 1A.

FIGS. 2A, 2B, 2C, and 2D are plots showing example data from a numerical simulation of a reservoir system.

FIG. 3 is a flow chart showing an example technique for analyzing data associated with fluid injection.

Like reference symbols in the various drawings indicate like elements.

### DETAILED DESCRIPTION

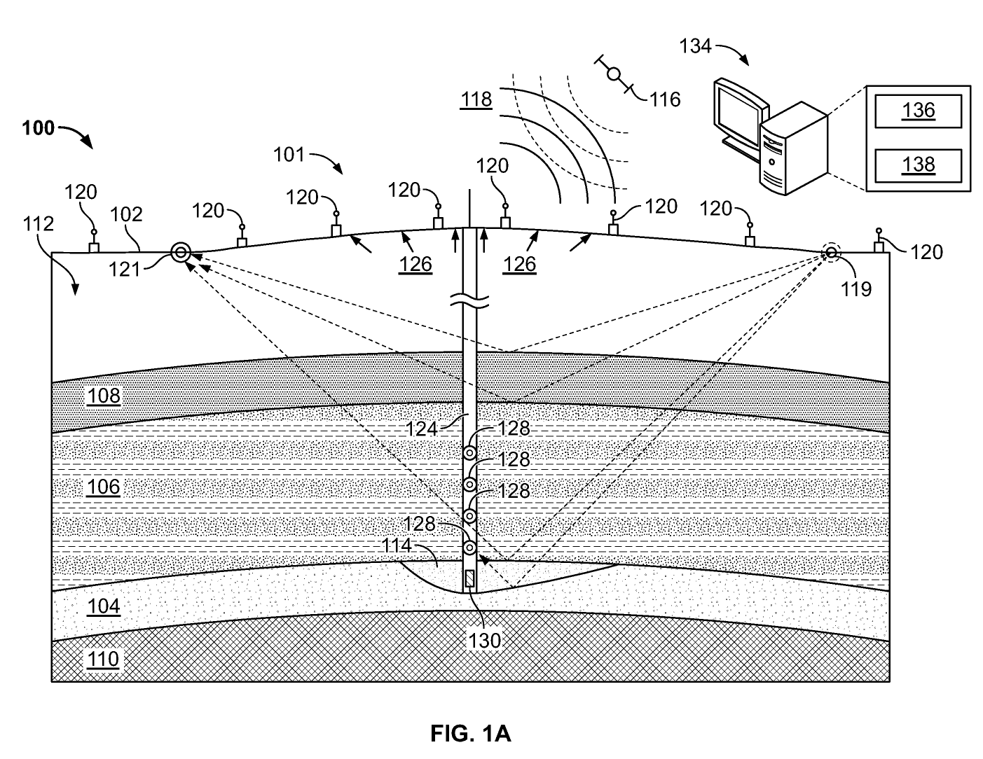

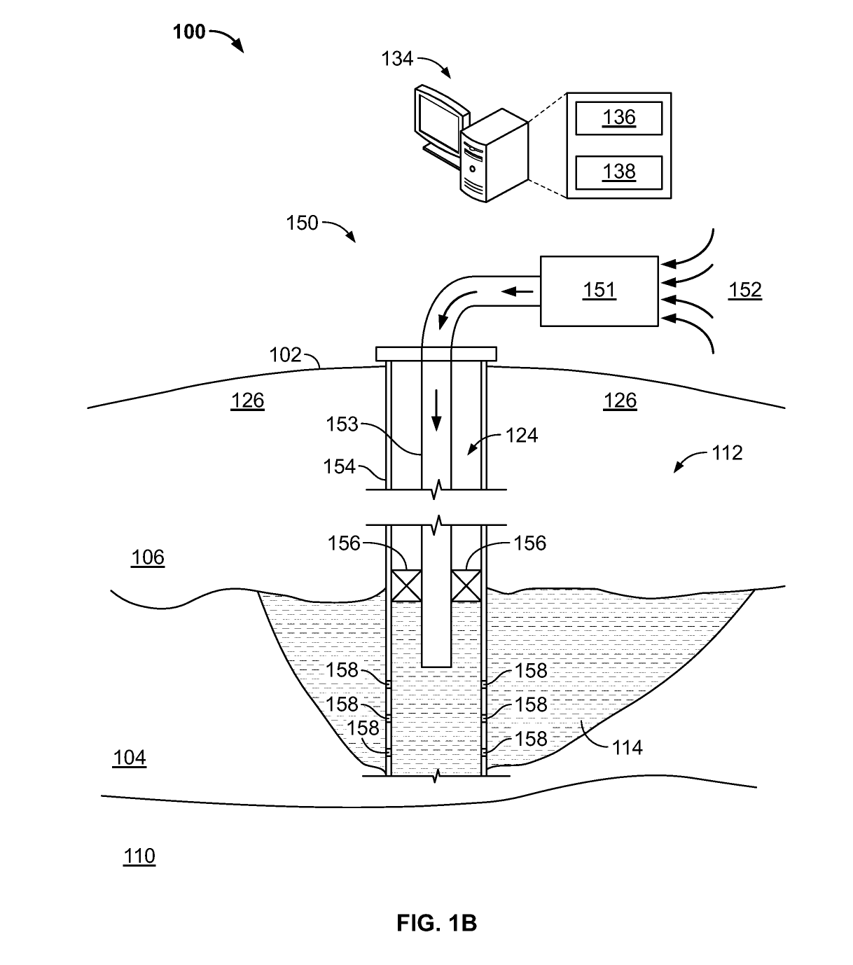

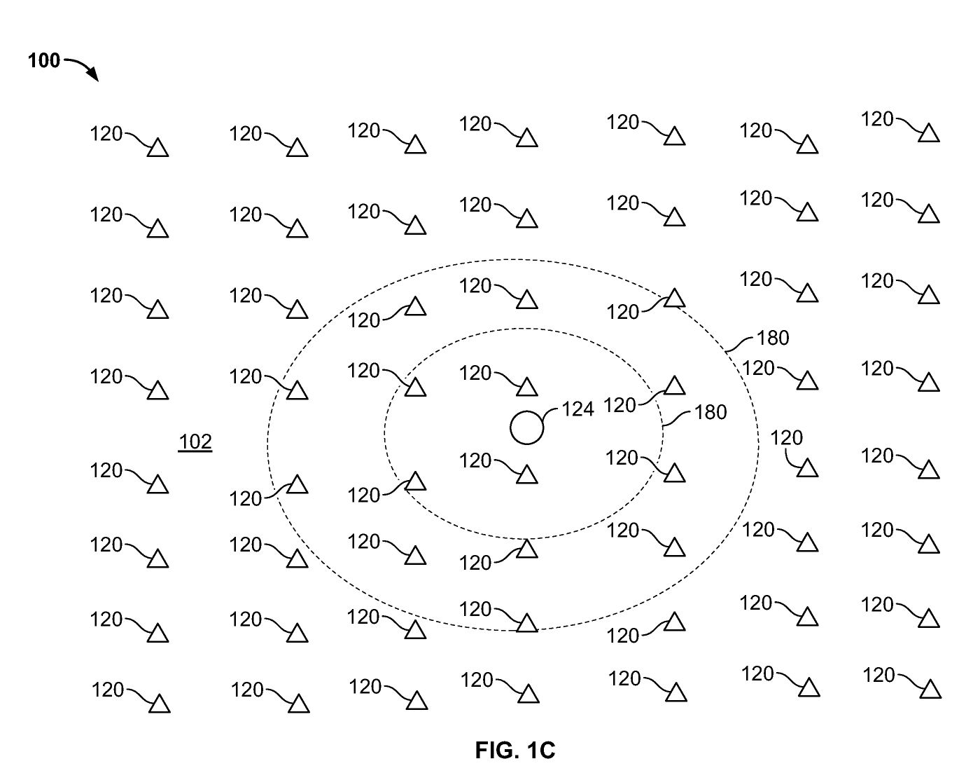

FIGS. 1A, 1B, and 1C are schematic diagrams (not to scale) showing aspects of an example reservoir system 100. The example reservoir system 100 generally includes a subsurface region 112, a measurement subsystem 101 shown in FIG. 1A, a fluid injection subsystem 150 shown in FIG. 1B, a data processing subsystem 134, and additional features shown and described herein. The reservoir system 100 may include fewer, additional, and/or different features and components. In some instances, the components and subsystems shown in FIGS. 1A, 1B, and 1C may be located at the well site and utilized concurrently with other components and subsystems. In some instances, one or more of the components and subsystems may be installed and/or operated at different times than the other components and subsystems. For example, the measurement subsystem 101 and the fluid injection subsystem 150 may be located at the well site and operated concurrently, or components of the measurement subsystem 101 and the fluid injection subsystem 150 may be present at the well site and/or operate at different times. Some of the components and subsystems may be located remote from the well site. For example, satellite systems, seismic sensors, data storage and/or data processing components, and/or other types of equipment may be located at remote locations away from the well site.

Generally, aspects of the example reservoir system 100 may be used to characterize, monitor, and/or analyze a subsurface reservoir 104 based on fluid injection. In the example shown in FIG. 1A, a plume 114 of injected fluid resides within the reservoir 104. In some implementations, field measurements of the reservoir's response to fluid injection are combined with reservoir modeling techniques to determine permeability, porosity, and total storage capacity of the reservoir 104. The reservoir 104 may be analyzed as an ongoing carbon dioxide or natural gas sequestration site, and/or as a candidate for a future carbon dioxide or natural gas sequestration site. Measuring the response of the reservoir 104 to injection of a fluid (e.g., air, carbon dioxide, natural gas, flue gas, nitrogen, water, and/or another fluid) may provide a relatively inexpensive way to characterize properties of the reservoir in situ. For example, geomechanical, hydrogeological, and other properties of the reservoir may be determined based on the injection of an inexpensive fluid, such as air or flue gas.

In some implementations, data analysis can determine, for example, a maximum rate at which carbon dioxide can be injected into the reservoir 104 such that reservoir pressure does not exceed the pressure at which the confining formation would fracture, cause fault motion, or induce seismicity. The injected fluid trapped beneath the confining layer may elucidate the structure of the bottom of the confining layer, while the plume's migration can be imaged to reveal the likely migration pathways of buoyant fluids in the reservoir and to identify potential leakage pathways such as faults, fractures, or abandoned wells.

In some cases, air or another test fluid or a surrogate fluid is injected as a proxy for carbon dioxide. For example, injecting air to test a candidate sequestration site may have one or more of the following advantages: test injections can be performed before a project incurs the significant costs of carbon dioxide capture and transport; leakage of air may be innocuous; the air injection provides a strong test of sequestration because air is more mobile at reservoir conditions than carbon dioxide; low-density air can be more easily imaged seismically, and as such, the air trapped beneath the confining layer can elucidate its structure.

Various types of data collection and/or data analysis techniques may be used to achieve one or more advantages. In some cases, vector surface deformation measurements may be combined with fluid flow modeling to characterize and monitor carbon dioxide sequestration reservoirs. GPS, airborne or satellite Interferometric Synthetic Aperture Radar (InSAR), and/or other geodetic measurement systems may be used to measure (e.g., at millimeter accuracy in some cases) three-dimensional deformation of the surface 102 over the reservoir 104. Space geodesy (e.g., GPS, InSAR) may allow measurements of both horizontal and vertical deformation with relatively low cost and high accuracy. Horizontal deformation is often more sensitive to reservoir properties than vertical deformation. This sensitivity may allow more stringent tests of predictions of geomechanical models and/or improve the accuracy of inversions for reservoir properties. Repeat GPS can measure three-dimensional deformation directly. InSAR can provide measurement of changes in range along the line of sight between the surface to the antenna. The combination of range changes from multiple InSAR viewing geometries may allow determination of three-dimensional vector deformation.

Measuring three-dimensional vector surface deformation may provide additional, and potentially more useful, information than measuring scalar changes in line-of-sight. For example, in some cases, vector displacements are particularly sensitive to the opening of fractures. A network of GPS receivers can provide high-accuracy three-dimensional data with high time resolution. InSAR observations from multiple viewing geometries may be used to obtain three-dimensional vector displacements with continuous spatial sampling, but in some cases at coarser temporal sampling than provided by GPS.

Well logs, historic seismic data, and/or other existing sources of information may be used to construct an initial model of the subsurface region 112 prior to injecting fluid. For example, existing data may be used to identify geologic structure characteristics and reservoir material properties that can be used to generate an initial estimated geologic model. The geologic model may serve as input for initial flow simulation and surface deformation calculations. Such geological models may be constrained by existing well logs, seismic information, etc.

After constructing the initial estimated geologic model and generating initial flow simulations, fluid may be injected into the reservoir 104, and the reservoir response may be measured and analyzed. The geodetic information collected by GPS, InSAR, and/or other measurements may be used in two separate and complementary manners. For example, the surface deformation data can be inverted to provide an estimate of the permeability and stress fields in the subsurface; and the surface deformation can be compared with the predicted surface deformation from flow modeling that incorporates geomechanics. Analysis may be carried out by iterating between the reservoir properties obtained from inversion of geodetic information, and the geodetic signal predicted by the flow simulation. Flow modeling may be carried out using a software product, such as the Generalized Equation-of-State Model (GEM) Compositional Reservoir Simulator made available by Computer Modeling Group, Ltd. GEM is capable of simultaneously modeling geomechanical deformation, flow of gases and liquids, and carbon dioxide dissolution into the aqueous phase as part of its carbon dioxide sequestration software suite. As another example, one or more aspects of flow modeling may be carried out using the Eclipse package offered by Schlumberger. Additional and/or different types of programs, including commercially-available software packages and custom-built programs, may be used.

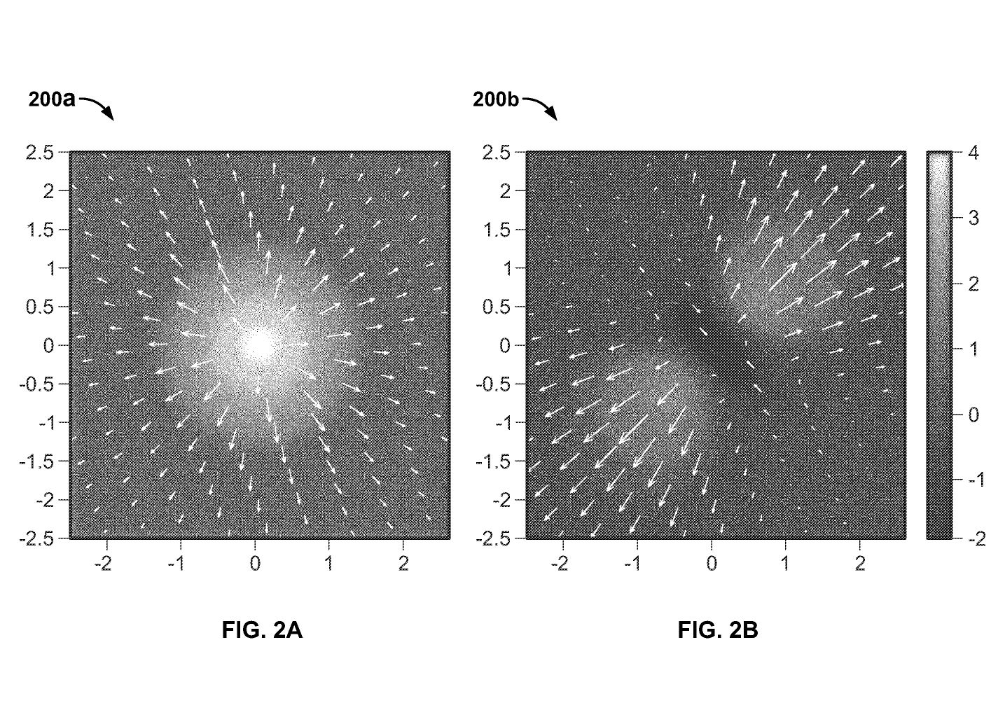

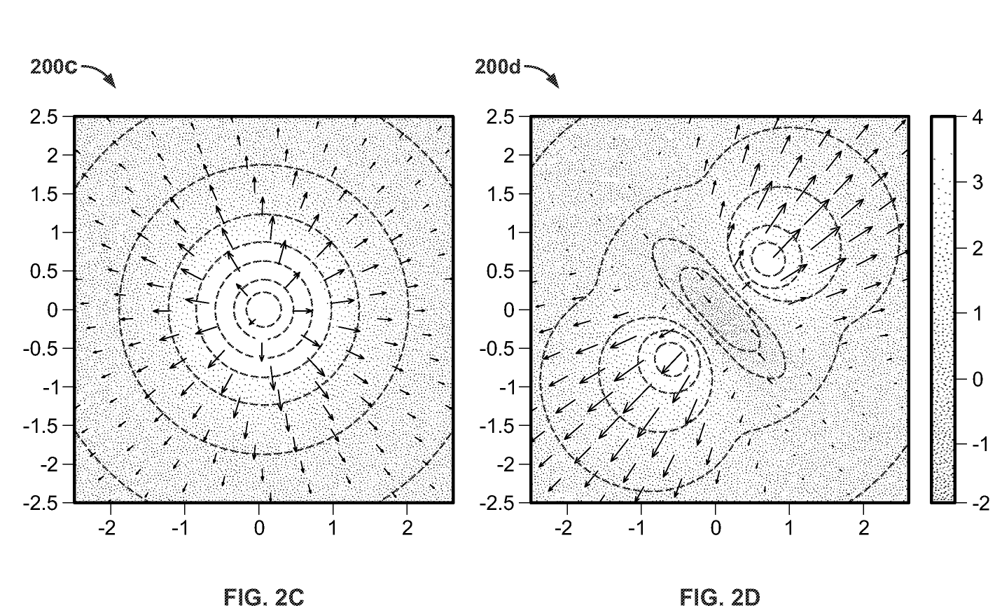

Various aspects of the permeability field may be determined through three-dimensional geodetic information along with fluid flow models. For example, such techniques may be used to determine anisotropy, heterogeneity, and magnitude of permeability. In addition, the effects of fractures on elastic deformation and on flow may be characterized in an internally consistent way in order to obtain improved constraints on fracture characteristics. For example, geodetic measurements are sensitive to the total volume of cracks, but typically do not discriminate between a single large fracture and multiple small ones aggregating to the same volume. However, the permeabilities of these two end members differ greatly. Viewed the other way around, differing crack distributions with the same permeability can have significantly different volume changes. Thus, analysis of three-dimensional geodetic data along with fluid flow models may provide additional types of data that are not available through some conventional approaches. FIGS. 2A, 2B, 2C, and 2D, described in more detail below, show examples of three-dimensional geodetic data analysis.

The example subsurface region 112 shown in FIG. 1A includes sub-reservoir rock 110, the reservoir 104, cap rock 106, overburden 108, and possibly additional features beneath the surface 102. The subsurface region 112 may include additional and/or different types of geologic features and characteristics. For example, the subsurface region 112 may include multiple reservoirs, or the subsurface region 112 may not include an overburden 108. The reservoir 104 can be a subsurface geologic formation that is being tested, monitored, and/or otherwise analyzed in connection with fluid storage activities, such as, for example, long-term storage of carbon dioxide, natural gas, and/or other fluids. In some example implementations, the reservoir 104 is a carbon dioxide or natural gas sequestration site, and an accurate understanding of aspects of the reservoir system 100 can be used to better design fluid injection activities. In some example implementations, the reservoir 104 is a candidate site for carbon dioxide or natural gas sequestration, and the reservoir system 100 is used to determine the reservoir's suitability for sequestration activities.

The reservoir 104 may be composed of porous rock that readily conducts and stores fluids. The reservoir 104 can generally have any topographical shape, thickness, and/or geometry. In some example cases, the reservoir 104 may range from one to hundreds, or possibly even thousands, of meters in thickness. The reservoir rock may include faults, fractures, and/or any type of natural or induced discontinuities. In some implementations, the reservoir 104 is a natural oil and gas reservoir, a natural saline aquifer, or another type of natural fluid reservoir. For example, the reservoir 104 may be a depleted or an actively producing oil and/or gas reservoir, or in some cases, there may be no planned, active, or past production activities associated with the reservoir 104.

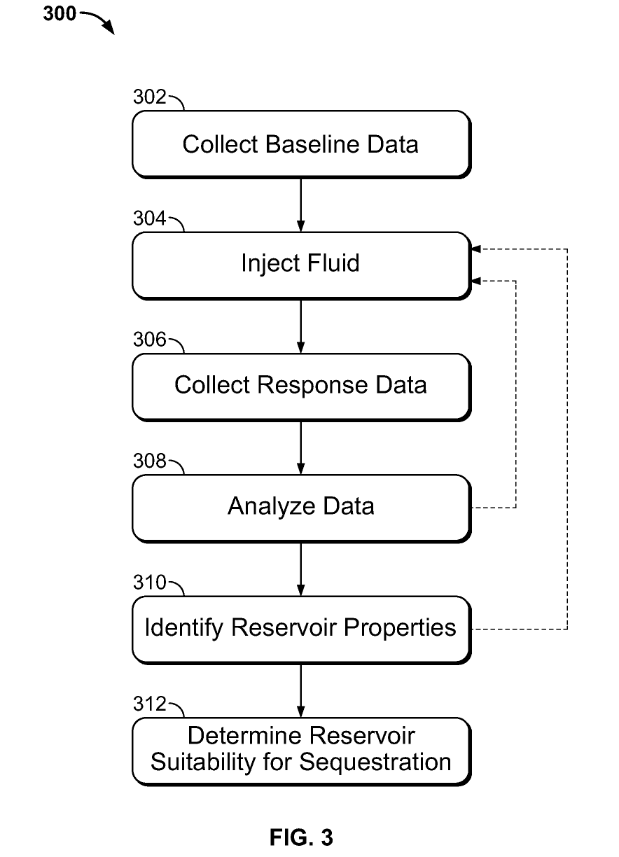

The sub-reservoir rock 110 resides below the reservoir 104, and the cap rock 106 resides above the reservoir 104 in the subsurface region 112. The cap rock 106, the sub-reservoir rock 110 and/or other geologic features may define boundaries of the reservoir 104. For example, the cap rock 106 and/or other subsurface features not shown in FIGS. 1A and 1B may define a lateral and/or vertical extent of the reservoir 104. The sub-reservoir rock 110 may include, for example, pre-Cambrian non-sedimentary rock forming a basement of the reservoir 104. The cap rock 106 may include relatively impermeable material that could prevent substantial amounts of buoyant fluid from escaping the reservoir 104. For example, the cap rock 106 may include rock that has a significantly lower permeability than the reservoir rock. The cap rock 106 may, in some instances, include leaks that allow fluid to escape the reservoir 104, and the example techniques described herein, such as the process 300 shown in FIG. 3, may be used to detect such leaks and/or other features that compromise the storage capacity of the reservoir 104.

The reservoir system 100 includes a well bore 124 defined in the subsurface region 112. The well bore 124 can have any shape, orientation, and/or configuration suitable for injecting fluid into the reservoir 104. For example, the well bore 124 may include vertical, horizontal, slant, and/or other well bore orientations. The well bore 124 may include cased and/or uncased portions. The well bore 124 may include features and/or tools not specifically shown in the figures. In some implementations, all or part of the well bore 124 may have been used for production, exploration, fracturing, fluid injection, and/or other activities.

The fluid injection subsystem 150 of the example reservoir system 100 injects fluid into the reservoir 104. FIG. 1B shows features of an example fluid injection subsystem 150 that injects air 152 into the reservoir to form the plume 114 shown. Different types of fluid injection systems that include additional and/or different features may be used to inject air and/or any of other injectate that may be used. Casing 154 may be cemented or otherwise secured in the well bore 124. Alternatively, all or part of the well bore may be uncased. Where the well bore 124 is cased in the reservoir 104, perforations 158 may be formed in the casing 153 to allow the injected fluid to flow into the reservoir 104. Perforations 158 may be formed using shape charges, a perforating gun, and/or other tools.

As shown in FIG. 1B, a working string 153 resides in the well bore 124. The working string 153 may include coiled tubing, sectioned pipe, and/or other types of tubing and/or pipe. The packers 156 shown in FIG. 1B seal the annulus of the well bore 124 above the reservoir 104. In some cases, packers 156 may be placed in additional and/or different locations to isolate one or more zones of the subsurface region 112 for fluid injection. For example, additional packers may be placed below the perforations 158 and/or in other locations. The packers 156 may include mechanical packers, fluid inflatable packers, sand packers, and/or other types of packers.

In the example shown in FIG. 1B, the working string 153 receives fluid from a compressor 151. The compressor 151 receives air 152 from the atmosphere, pressurizes the air in the compressor 151, and communicates the compressed air into the working string 153. The compressor 151 may be coupled to a motor, a gas turbine, a wind turbine, and/or another type of system that provides mechanical or electrical energy to pressurize the air for injection. The compressed air is communicated through the working string 153, into the well bore 124, and into the reservoir 104, thus forming the plume 114.

In some cases, other fluids are injected into the reservoir 104 instead of, or in addition to, air. For example, a fluid for storage, such as carbon dioxide and/or natural gas, may be injected into the reservoir 104. In some cases, the injected fluid is a surrogate for the fluid for storage. The surrogate fluid may include none or only trace amounts of the fluid for storage. For example, the injected fluid may include air, flue gas, water, nitrogen, argon, oxygen, and/or other surrogate fluids. In some instances, the injected fluid includes a test fluid that is more mobile in the reservoir 104 than carbon dioxide. For example, the test fluid may be less viscous and/or less dense under reservoir conditions than carbon dioxide. Fluids that, unlike air, are not available at the well site may be transported to the well site, for example, by pipelines, trucks, and/or other types of infrastructure. In some cases, the fluid injection subsystem 150 includes pump trucks, fluid tanks, and/or other types of structures that communicate fluid to the working string 153. The pump trucks may include mobile vehicles, immobile installations, skids, hoses, tubes, fluid tanks or reservoirs, pumps, valves, and/or other suitable structures and equipment. In some instances, the fluid injection process and/or components of the fluid injection subsystem 150 may be controlled based on instructions received from the data processing subsystem 134.

Generally, any injected fluid may form a plume in the reservoir. The plume of injected fluid may extend substantially in all directions in the reservoir 104. The plume may extend preferentially in a limited number of directions in the reservoir, for example, spreading and fingering based on varying permeabilities, fractures, and other features in the reservoir. The plume may be buoyant in the reservoir 104 and rise to the interface with the cap rock 106. In the example shown in FIGS. 1A and 1B, the injected air forms a plume 114.

The plume may be imaged in the subsurface region 112, for example, using seismic imagery. In some cases, other fluids, including fluids that are native to the subsurface region 112, may also be imaged. The pressure of the plume may cause mounding 126, which deforms the surface 102 above the reservoir 104. Deformation of the surface 102 caused by mounding may include changes in topography, spreading, shifting, rising, sinking, as well as combinations of these and/or other effects. Mounding at the surface 102 can occur, for example, when a volume of fluid injected in the reservoir 104 mechanically deforms the subsurface region 112, causing movement at the surface 102. In some cases, the deformation of the surface 102 due to mounding 126 may be observable at the surface 102, for example, using geodetic surface measurements. In some example implementations, the surface 102 may deform at a rate of approximately 5 millimeters per year due to the injection of fluid in the reservoir 104. Mounding may occur at different rates, depending on a number of factors. The mounding 126 may be observable (e.g., may cause a measurable surface deflection) beyond the surface projection of the plume in the reservoir 104. For example, the mounding 126 may extend two or more times farther from the well bore 124 than the plume 114. Mounding 126 may include three-dimensional movement of the surface 102. For example, mounding may cause points on the surface to move vertically (i.e., perpendicular to the surface 102) and/or in longitudinal and latitudinal directions (i.e., parallel to the surface 102). FIG. 1C shows example contours 180 that demonstrate the topography of the surface 102 resulting from mounding 126. Generally, the topography of the surface may be modified in many different ways by mounding, and the change in topography of the surface 102 shown in FIGS. 1A and 1C provide one example. Additional examples are shown in FIGS. 2A, 2B, 2C and 2D.

The example measurement subsystem 101 includes a GPS monitoring network, a seismic monitoring system, a pressure monitoring system, and InSAR telemetry systems. A measuring subsystem may include additional, fewer, and/or different types of equipment and techniques. The pressure monitoring system includes one or more pressure transducers 130 in the well bore 124. The pressure transducers monitor pressures in the well bore 124. The pressure transducers may monitor the pressure of the injected fluid during and/or after the fluid injection. In some cases, a sudden drop in the observed pressure may indicate the presence of a leak allowing fluid to quickly escape the reservoir 104, whereas observing relatively steady pressures over time, without large or rapid variations in pressure, may indicate the presence of an efficient fluid seal about the reservoir 104.

The seismic monitoring system includes a seismic impulse source 119 at the surface 102, a surface seismic receiver 121 at the surface 102, and downhole seismic receivers 128 in the well bore 124. A seismic monitoring system may include fewer, additional and/or different components. For example, seismic monitoring may be implemented by a different number sources and/or receivers at fewer, additional, and/or different locations in the reservoir system 100. Seismicity may be induced by the injection or from an artificial seismic source.

In some aspects of operation, the seismic impulse source 119 generates an acoustic signal. The acoustic signal propagates through the subsurface region 112 and interacts with geologic features of the subsurface region 112. For example, the acoustic signal may traverse and/or interact with the overburden 108, the cap rock 106, the reservoir 104, the sub-reservoir rock 110, the interfaces between them, fractures, faults, and/or other types of discontinuities and features in the subsurface region 112. The acoustic signal may be partially reflected, absorbed, transmitted, and/or modified in the subsurface region 112 based on the lithologies, fluid content, and/or other characteristics. The acoustic signal may be detected at the downhole seismic receivers 128 and/or at the surface seismic receiver 121. The detected signal may be analyzed, for example, using software, computer programs and/or other types of automated processes. Analysis of the seismic data may generate seismic images of the plume 114. Analysis of the seismic data may provide information on seismic activity and/or other types of mechanical movement in the subsurface region 112. Analysis of the seismic data may provide information on faults, fractures, and/or other types of discontinuities in the subsurface region 112.

In some instances, the buoyant injected fluid rises towards the cap rock 106 and spreads outward away from the injection well, until it reaches a confining layer. The speed with which this happens provides constraints on hydrogeological properties. The fluid may split into multiple tongues or finger and/or into multiple layers in the reservoir 104. Changes in the reflectivity and/or the appearance of additional reflectors in the reservoir interval may indicate one or more fluid fronts in the reservoir 104. Accordingly, such information may be used to determine the location of the plume of injected fluid in the reservoir. Seismic reflectivity at an interface depends on the contrast of impedance across the interface, where the impedance of a medium, Z, is the product of its seismic velocity times its density: Z=Vρ. For example, for normal incidence between two media of impedance Z₁ and Z₂, the reflection coefficient is given by R=(Z₁−Z₂)/(Z₁+Z₂). Air and carbon dioxide have similar seismic velocities (approximately 390 and 350 m/s, respectively), and air is much less dense than carbon dioxide (approximately 120 and 500 kg/m³, respectively). Thus, air is a stronger seismic reflector than carbon dioxide under typical reservoir conditions.

The example geodetic measurement system shown in FIG. 1A includes GPS and satellite InSAR systems. Additional and/or different types of geodetic measurement systems (e.g., aerial InSAR, tilt meters, laser ranging, laser leveling) may be used. The example GPS monitoring network shown in FIGS. 1A and 1C includes GPS receivers 120 at the surface 102, which receive signals from GPS satellites. The GPS receivers 120 may be positioned for detecting movement associated with mounding of the surface 102. In some instances, the GPS receivers 120 reside at multiple locations up to and/or beyond a radius of several hundred meters or kilometers from the well bore 124. The network of GPS sites may provide high-accuracy three-dimensional surface deformation data at selected points.

FIG. 1C shows an example of GPS receivers 120 arranged generally in a grid at the surface 102. A different number of GPS receivers 120 may be used, and the GPS receivers 120 may be arranged in a different manner. For example, the GPS receivers may be arranged in radial, linear, geometric, random, and/or other types of patterns. The locations of the GPS receivers 120 may be selected based on terrain, accessibility, signal strength, instrument sensitivity, and/or other factors.

Multiple geodetic measurement technologies may be used in coordination to monitor vector surface deformation. In some example implementations, two networks, each with approximately thirty geodetic markers, are used. In each network, a subset (e.g., two, five, etc.) of the markers may be monitored continuously to provide high resolution temporal coverage. The remaining markers may be observed on a lower time resolution (e.g., weekly) using groups (e.g., six to eight) of roving receivers, providing a measurement at each marker on a less frequent basis (e.g., monthly). This example measurement scheme may provide sufficient temporal coverage to resolve geologic signals in some example systems. In some other examples, a different number of geodetic markers are used with a similar or a different temporal sampling technique.

An airborne SAR system, for example NASA's so-called UAVSAR (Uninhabited Aerial Vehicle Synthetic Aperture Radar) can also be used to obtain full three-dimensional vector displacements over a broad region. In some cases, the data obtained by an airborne SAR may be at coarser temporal sampling than provided by GPS. InSAR observations from multiple satellites (e.g., ENVISAT, RADARSAT, ALOS-PALSAR, and/or others) from multiple look directions may be used to obtain better geometrical and temporal coverage.

The satellite InSAR system shown in FIG. 1A includes an InSAR satellite 116. The satellite 116 transmits electromagnetic signals 118 that interact with the surface 102. At least a portion of the signals 118 are reflected from the surface 102 and received by the satellite 116. Geometric features of the surface 102 and/or movement of the surface 102 in the direction parallel to the line of sight to the satellite may be detected based on the InSAR data. Geodetic data collected by the GPS network, the InSAR instruments, and/or other systems may generally provide one, two or three dimensions of spatial data relating to geometry and/or movement of the surface 102. The geodetic data may be used to detect mounding and/or to generate multi-dimensional vector plots representing the surface's dynamic behavior, which may indicate the surface's response to the fluid injection.

FIGS. 2A, 2B, 2C, and 2D are plots showing example geodetic data from a numerical simulation of a reservoir system. Horizontal and vertical displacements are both shown in the plots 200a, 200b in FIGS. 2A, 2B. (For clarity, the data from plot 200a is repeated with dashed contour lines in plot 200c of FIG. 2C, and the data from plot 200b is repeated with contour lines in plot 200d of FIG. 2D. The inner contour in plot 200c indicates the highest vertical displacement in that plot; the outer contour in plot 200c indicates the lowest vertical displacement in that plot. The inner contour about the origin in plot 200d indicates the lowest vertical displacement in that plot; the inner contours offset to the NE and SW of the origin in plot 200d represent the highest vertical displacements in that plot.) A comparison of the plots 200a, 200b shows one example of how the presence of fractures may affect three-dimensional surface deformation. In particular, a comparison of the plots reveals the differences in three-dimensional surface deformation that would result from injecting fluid into an isotropic medium (200a) versus injecting fluid into oriented cracks (200b). Both plots 200a, 200b represent a square region 5,000 meters in each horizontal direction. Both plots 200a, 200b show displacements resulting from the inflation of an isotropic source with volume increase of 30,000 cubic meters at a depth of one kilometer. In both plots 200a, 200b, the magnitude and direction of horizontal displacements are shown by arrows and the magnitude of vertical displacements are shown by the stippling density in the background. (The vertical displacements in plots 200a, 200b are represented by contour lines and stippling density in plots 200c, 200d respectively.) Both plots 200a, 200b represent lengths on the same scale. The vertical displacement length scale shown is in units of millimeters.

The plot 200a in FIG. 2A shows three-dimensional surface deformation for an isotropic volume source at a depth of one kilometer in an elastic halfspace. In the numerical simulation used to generate the plot 200a, the volume source is equivalent to a sphere having a radius of 20 meters. In the plot 200a, the horizontal displacements are generally oriented radially away from the origin, with a maximum of 1.6 millimeters displacement at 1.2 kilometers from the origin. The maximum vertical displacement is 3.8 millimeters.

The plot 200b in FIG. 2B shows three-dimensional surface deformation caused by a vertical, NW-SE trending tensile dislocation of equal volume change and equal depth as the volume source used to generate the plot 200a. The region above the source subsides 1.2 millimeters. The maximum uplift of 2.1 millimeters occurs at approximately one kilometer away from the source. The horizontal displacements are oriented predominantly NE-SW away from the source, with a maximum value of 2.7 millimeters at approximately 1.1 kilometers SW and NE of the source. As in this example, for the opening of a vertical fracture, the horizontal surface deformation typically exceeds the vertical surface deformation.

All or part of the data processing subsystem 134 may be located remote from the well site. In some implementations, the reservoir system 100 includes one or more instrument trucks, immobile installations, and/or other suitable structures at the well site that house all or part of the data processing subsystem 134, for example, along with communication infrastructure, power systems, and/or other types of equipment. The data processing subsystem 134 may include one or more computing devices each having a memory 136 and a data processor 138. For example, the data processing subsystem 134 may include one or more microcontrollers, personal computers, laptop computers, servers, server clusters, databases, and/or other types of computing devices. In some instances, the data processing subsystem 134 runs software that can simulate aspects of the fluid injection, fluid flow in the reservoir 104, mechanics of the reservoir 104, and/or other relevant dynamics. In some cases, the injection of fluid into the reservoir may be controlled and/or analyzed based on the simulations. The data processing subsystem 134 runs software that can analyze data from the measurement subsystem 101, identify characteristics of the reservoir based on data from the measurement subsystem 101, and/or determine aspects of the reservoir's suitability for carbon dioxide and/or natural gas sequestration. For example, the software may be used to implement one or more of the operations 308, 310, 312 of the process 300 and/or other types of operations.

Generally, aspects of the data processing subsystem 134 may be implemented by digital electronic circuitry, computer software, firmware, and/or hardware. The data processing subsystem 134 may store data and/or computer programs in a computer storage medium, such as the memory 136. Computer storage media include all forms of volatile and non-volatile memory, for example, semiconductor memory devices (e.g., EPROM, EEPROM, flash memory devices, and others), magnetic disks (e.g., internal hard disks, removable disks, and others), magneto optical disks, and CD ROM and DVD-ROM disks. The data processing subsystem 134 may include a data processing apparatus, such as the data processor 138, that performs operations (e.g., the operations 308, 310, 312 of FIG. 3, numerical analysis, computer simulation, and/or other types of operations). Generally, a data processing apparatus receives input data and executes instructions to generate output data. A data processing apparatus may include any kind of apparatus, device, and/or machine for processing data, including, for example, a programmable processor, a computer, a system on a chip, a microcontroller and/or similar devices. A data processing apparatus may include special purpose logic circuitry, e.g., an FPGA (field programmable gate array) or an ASIC (application specific integrated circuit). A data processing apparatus may execute software, computer code, computer program products, and/or other forms of machine-readable instructions.

Various components of the reservoir system 100 can communicate with each other, for example, directly, indirectly, through a communication network, and/or in another manner. Components of the reservoir system 100 may communicate directly over wired and/or wireless connections using any suitable digital and/or analog communication protocol. For example, components of the reservoir system 100 may communicate over copper wires, wireless radio frequency signals, hydraulic signals, digital signals, analog signals, and/or in another manner. Components of the reservoir system 100 may communicate over a digital communication network. Examples of communication networks include a local area network (“LAN”) and a wide area network (“WAN”), an inter-network (e.g., the Internet), a network comprising a satellite link, and peer-to-peer networks.

Various components and/or aspects of the data processing subsystem 134 may communicate with other components or subsystems in the reservoir system 100. For example, the fluid injection subsystem 150 may receive fluid injection parameters (e.g., pressure, volume, flow rate, timing, and/or other parameters of fluid injection), commands, and/or other information from the data processing subsystem 134; the data processing subsystem 134 may receive status information and/or other types of information from the fluid injection subsystem 150. As another example, the data processing subsystem 134 may receive baseline data, response data, status updates, and/or other types of information from the measurement subsystem 101; the measurement subsystem 101 may receive commands and/or queries for data from the data processing subsystem 134. The data processing subsystem 134 may include multiple independent subsystems that each interface with and/or control different components or subsystems in the reservoir system 100.

FIG. 3 is a flow chart showing an example process 300 for collecting information about a subsurface reservoir. Some or all of the operations in the process 300 may be implemented by one or more components of the example reservoir system 100 shown in FIGS. 1A and 1B. In some implementations, the process 300 may include additional, fewer, and/or different operations performed in the same or a different order. Moreover, one or more of the individual operations and/or subsets of the operations in the process 300 can be performed in isolation and/or in different contexts to achieve the same and/or different types of results. Output data generated by the process 300, including output generated by intermediate operations, can include stored, displayed, printed, transmitted, communicated and/or processed information.

In the following description of the example process 300, the subsurface reservoir is described as a carbon dioxide sequestration site and/or as a candidate site for carbon dioxide sequestration. The example process 300 may be modified for and/or applied to reservoirs that are candidate sites for sequestration of other fluids for storage, for example, reservoirs for storing natural gas or other types of reservoirs.

In some cases, one or more operations of the process 300 may be implemented to monitor a carbon dioxide sequestration site, for example, over the time period when carbon dioxide is being injected into the subsurface reservoir and/or for months and years after carbon dioxide has been injected for storage. In such cases, the process 300 may be useful for detecting leaks and/or seismic activity, ensuring environmental goals are achieved, and/or ensuring compliance with relevant governmental regulations, contractual obligations, and other requirements.

In some cases, one or more operations of the process 300 may be implemented to characterize a candidate carbon dioxide sequestration site, for example, to determine whether the candidate site is a viable option and/or to compare the candidate site to other sites. In such cases, the process 300 may be useful for detecting leaks and/or seismic activity, for predicting the capacity and/or capability of the reservoir for storing carbon dioxide, for detecting flow properties of the injection formation, for predicting compliance with relevant governmental regulations, etc.

At 302, baseline data is collected. For example, baseline seismic, pressure, geodetic, and/or other types of data may be collected. The baseline data may include data collected by sensors at a surface above the subsurface reservoir, sensors in a well bore, satellite systems, aerial systems, and/or sensors and measurement instruments at other locations. The baseline data may be used to identify an initial state of the reservoir. The baseline data may be used to generate an initial geologic model for the reservoir. All or part of the baseline data may be compared with the response data later collected (at 302). As such, the baseline data may be collected by any of the systems and/or techniques that are used to collect the response data (at 302), as well as additional and/or different types of systems, apparatus, and/or techniques.

In some example implementations, the baseline data include geodetic measurements collected using a combination of GPS (providing high temporal resolution), satellite and/or airborne InSAR images (providing high spatial resolution). The GPS and/or InSAR data may include four dimensions of data—three spatial dimensions and a time dimension. Tilt meters, laser ranging instruments, laser leveling instruments and/or other types of equipment may also be used. In some cases, the geodetic data from one or more measurement system may include only one or two spatial dimensions. The baseline data may include a time series of data, or in some cases, the baseline data may include data for a single time point. In some example implementations, the baseline data include seismic image data of the subsurface. The seismic image data may include a vertical seismic profile (VSP) prior to injection.

At 304, fluid is injected in a subsurface reservoir. In some implementations, the example fluid injection subsystem 150 shown in FIG. 1B and/or another type of system may be used to inject fluid into the subsurface reservoir. The fluid may be injected through a well bore defined in the subsurface reservoir. The well bore may be drilled before, after, or while the baseline data is collected at 302. In some implementations, multiple well bores are drilled and/or tested. The fluid may be injected through each of multiple well bores simultaneously or in series, or the fluid may be injected through a single well bore. In some cases, multiple different fluids are injected together and/or sequentially. For example, air and water may be mixed and injected together. As another example, air may first be injected to identify leakage pathways, and water may subsequently be injected to create a faster pressure build-up in the reservoir.

In some cases, the fluid is injected into the reservoir for a given period of time or until a given volume or mass of the fluid has been injected. For example, the volume may be determined based on the seismic techniques by which the baseline and/or response data are collected (at 302, 306). In some implementations, the injected volume of fluid is determined based on a volume predicted to induce a demonstrable seismic signal. In some implementations, the injected volume of fluid is determined based on a volume needed to deform the surface sufficiently for detection by GPS, laser ranging, leveling, tilt meters, InSAR imagery, and/or other techniques. In some cases, the injected fluid includes tracers that can be used to monitor the fluid in the reservoir, in the air, in the soil, and/or above. Any suitable type of tracer may be used, for example, chemical tracers, radioactive tracers, and/or other types of tracers.

The injected fluid may include one or more fluids transported to the well bore, for example, by a pipeline, a truck, and/or in another manner. The fluid may be housed at the well system in tanks, conduits, and/or other types of structures. In some cases, the fluid (e.g., air) is collected from the local atmosphere at or near the well surface. The fluid may be pressurized, for example, by a compressor at the surface or in the well bore, and the pressurized fluid may be communicated through a conduit disposed in the well bore. Seals (e.g., packers and/or other types of seals) in the well bore may be used to isolate a region of the formation for the fluid injection.

The fluid may be injected into the subsurface reservoir at low pressures, high pressures, or intermediate pressures. For example, the fluid may be injected above or below a fracture initiation pressure, above or below a fracture propagation pressure, above or below a fracture closure pressure, and/or at other pressures. The injection pressure may be varied over time and/or at different locations in the reservoir. The pressure may be controlled, for example, by a compressor, a pump, a valve, and/or another type of pressure or flow control device.

The fluid injected into the subsurface reservoir can be any type of compressible or non-compressible fluid. The fluid may be pure gas, pure liquid, supercritical fluid, or a combination of gas and liquid phases. In some implementations, the injected fluid is primarily carbon dioxide. For example, when the reservoir is being used for carbon dioxide sequestration or when it is being tested, the injected fluid may include carbon dioxide that has been separated from other materials and/or that has been captured from another environment, atmosphere, or process. The carbon dioxide may be pure CO₂, or it may be CO₂ mixed with other substances, such as water, nitrogen, argon, oxygen, hydrocarbons, sulfur oxides (SOx), nitrogen oxides (NOx), hydrogen sulfide (H₂S), amine, ammonia, trace materials and/or others. In some cases, carbon dioxide is mixed with other substances in various proportions, as in flue gas that has gone through a post-combustion carbon dioxide capture process. For example, if the flue gas came from combustion of natural gas, the flue gas may include carbon dioxide in addition to trace amounts of SOx, NOx, and/or other substances. In some implementations, instead of a fluid containing primarily carbon dioxide, a surrogate fluid is injected. The surrogate fluid may contain no carbon dioxide. Or in some cases, a surrogate fluid, such as air, may include insubstantial amounts of carbon dioxide. The surrogate fluid may have one or more chemical constituents. In some examples, the surrogate fluid includes air, water, nitrogen, oxygen, argon, hydrocarbons, and/or others. The surrogate fluid may include brine water and/or other fluids from a subsurface formation.

In some implementations, the injected fluid is a test fluid. The test fluid may have properties that are advantageous for analyzing suitability of the reservoir for sequestration; the test fluid may be more mobile in the subsurface reservoir than carbon dioxide. For example, the test fluid may have a bulk fluid density less than the density that carbon dioxide would have under the same temperature and pressure conditions, and/or the test fluid may have a bulk fluid viscosity less than the viscosity that carbon dioxide would have under the same temperature and pressure conditions. The test fluid may have a density and viscosity less than the density and viscosity of carbon dioxide under the same conditions. The greater mobility of the test fluid may cause the test fluid to migrate to leaks, fractures, and/or other regions of interest faster and/or farther away than carbon dioxide would under the same conditions. In some examples, the test fluid can include air, flue gas, nitrogen gas, natural gas, and/or another type of fluid. The test fluid may include the fluid for storage mixed with other fluids. For example, flue gas may include approximately fifteen percent carbon dioxide by mass mixed with other types of gases.

Injecting a fluid into a porous reservoir at elevated pressure may have multiple effects. As one example effect, the elevated pressure may cause a pressure gradient that drives fluid away from the injection well. This fluid flow may result in additional pressure variations within the reservoir. The interaction of the pressure variations and the hydrogeological parameters such as porosity and permeability may determine how far and where the fluid flows through the formation. As another example effect, the increased pore fluid pressure may lead to increased volume of the local pore structure within the reservoir. Because the reservoir and surrounding rock are elastic, this local expansion of the reservoir can result in changes in stress and strain throughout the rock, as well as both horizontal and vertical deformation of the Earth's surface. Changes in internal stress, possibly with changes in pore pressure, can lead to reactivation of faults or to initiation of new fractures. In addition, the internal stress changes affect the permeability and porosity, coupling back into the flow.

At 306, response data is collected. The response data may include the same, additional, and/or different types of data as the baseline data collected at 302. The response data may be collected while the fluid is being injected at 304 and/or after the fluid is injected at 304. The response data may include seismic data, pressure data, geodetic data, and/or other types of data. In some implementations, the response data includes pressure data collected by pressure transducers in the well bore. The response data may include two-dimensional and/or three-dimensional seismic data collected at sensors in the well bore, at sensors above the reservoir, and/or at sensors in other locations. For example, sensors at or near the surface above the reservoir may generally include sensors at any latitude and longitude, including locations directly above the reservoir and locations not directly above the reservoir. That is to say, sensors above the reservoir may reside outside the surface directly above the reservoir.

Seismic data can be used to generate many different types of information about the reservoir. Seismic data can be used to monitor injection-induced seismicity. For example, seismic data may be used to detect mechanical perturbations in the formation rock caused by the injection of fluid (at 304). Seismic data can be used to characterize induced faulting or fracturing. For example, seismic data may be used to identify fractures induced and/or propagated by the injection of fluid (at 304). The seismic data can be used to generate seismic imagery of the reservoir, other portions of the subsurface region, and/or the test fluid in the subsurface region. For example, the seismic data may be used to generate images of the plume of injected fluid in the reservoir and/or the seismic data may be used to detect mechanical changes in the formation, such as fault slips and/or other seismic activity. In some implementations, the response data includes geodetic surface data collected by global positioning system (GPS) receivers above the reservoir, satellite or aerial InSAR instruments, tilt meters about the reservoir (e.g., in the well bore, at the surface, and/or at other locations about the reservoir), leveling instruments, laser ranging instruments, and/or other types of equipment. The geodetic data may be used to determine a change in topography and/or movement of the Earth's surface above the subsurface region.

In some implementations, the response data is collected over a period of minutes, hours, days, weeks, months, or years. In some cases, the response data is collected on a continuous or periodic basis. For example, one or more sensors may be sampled at close time intervals (e.g., seconds, milliseconds, microseconds, etc.), and/or one or more sensors may be monitored on a periodic basis at infrequent time intervals (e.g., minutes, hours, days, weeks, months, etc.). The response data may include digital data, analog data, and/or any type of data represented and/or stored in any medium. For example, the response data may include digital data stored in a computer-readable medium and/or other data formats. The response data may be stored and/or communicated to a database or another type of data repository. The response data may be stored on a common data server, or the response data may be distributed on multiple different data servers in different locations. The response data may be continuously or periodically augmented, updated, refined, or refreshed as additional data becomes available.

At 308, the response data is analyzed. For example, the response data may be compared to and/or otherwise analyzed in connection with the baseline data. In some cases, the response data may be analyzed independent of the baseline data. Analysis of the response data may include operations performed by a computing device, for example, by a data processing apparatus executing software, by a digital microcontroller, and/or by another type of computing device. Analyzing the response data may include identifying the subsurface reservoir's response to the injected fluid and/or identifying dynamic or static behavior of the fluid in the reservoir. Analysis of the response data may generate seismic images of the plume of injected fluid in the reservoir. Analysis of the response data may generate plots, diagrams, charts, and/or other representations of the reservoir's response to the injected fluid.

In some instances, analyzing the data may include identifying changes in the pressure of the fluid in the reservoir, identifying changes in seismic activity, identifying movement of the fluid through the reservoir, identifying movement of the surface above the reservoir (e.g., mounding), and/or identifying other geomechanical or hydrogeologic changes. In some instances, analyzing the response data may include identifying a three-dimensional geodetic response to the fluid in the reservoir based on three-dimensional geodetic data. In some instances, analyzing the response data may include identifying movement of the surface above the reservoir based on geodetic surface data. Other types of data analysis may be used.

At 310, properties of the subsurface reservoir may be identified based on the response data and/or the analysis of the response data. For example, a permeability in the reservoir, presence and properties of fractures and faults in the reservoir, presence and properties of leakage pathways for the injected fluid, mechanical (e.g., seismic) movement, and/or other properties may be identified. In some cases, properties of the reservoir may be identified based on the movement of the surface identified (at 308) from geodetic data. The properties of the reservoir may include hydrogeologic properties, geomechanical properties, and/or other types of properties. Example hydrogeologic properties include permeabilities in the reservoir, conductivity fields in the reservoir, and others. Example geomechanical properties include fractures in the reservoir, boundaries of the reservoir, compressibility, state of stress, mechanical properties, and others. In some implementations, the properties of the reservoir are monitored before, while, and/or after injecting carbon dioxide and/or another fluid into the reservoir.

Properties of the reservoir may be identified from surface measurements as well as down-hole measurements. The measurements may include two-dimensional and/or three-dimensional seismic profiles, for example, using GPS and InSAR to measure vector surface deformation. The measurements may also include measurements of seismicity induced by the fluid injection. Correlating local four-dimensional seismic images of the evolution of the plume with InSAR satellite images and GPS measurements of both uplift and horizontal motions may allow long term monitoring of plume movement without continuous and expensive seismic imaging. Furthermore, both the seismic and geodetic approaches may provide key information on pressure-induced fracturing that could potentially reduce the integrity of the reservoir.

Conceptually, identifying properties of the reservoir may involve solving the forward problem by discretizing coupled equations of flow and geomechanics using a finite difference, finite volume, and/or finite element approach. In practice, the solution of the coupled fluid and geo-mechanical equations can be carried out by a sequential or iterative method, in which the mechanics and flow problems are solved separately (sequentially) and then iterated, rather than simultaneously. In some examples, the fluid flow may be modeled according to the equations for multiphase Darcy flow; the geomechanics may be modeled according to the equations of equilibrium, assuming elastic or other constitutive relations. The geomechanical calculations may be used to calculate a deformation field based on pressures, stresses, and/or other mechanical properties of the rock. An additional simplification is sometimes made in solving the geomechanics part of the problem by replacing the finite element solutions with volume integrals of Green's functions for a homogeneous (or layered) elastic medium.

In some example implementations of the iterative technique, initial values for reservoir properties may be determined based on well logs, outcroppings, historical data, analog fields, average values, an initial guess and/or other types of information. The initial values of the reservoir properties may be used as input in fluid mechanical calculations (e.g., using the multiphase Darcy flow equations) to calculate pressure fields for the reservoir. The resulting pressure fields may then be used in geomechanical calculations to calculate a deformation field for the reservoir. The calculated deformation field may be compared to the measured surface deformation. In some cases, the raw geodetic data from the measurement system are converted to a format that is compatible with the calculated deformation field. For example, GPS data, InSAR data, seismic data, and/or other types of data may be converted to units, scale, and/or format compatible with a reservoir simulation software or program. If the calculated deformation field matches the measured deformation, then the initial values of the reservoir properties may be considered acceptable, and such values may be used (at 312) to determine suitability of the reservoir for sequestration. If the calculated deformation field does not match the measured deformation, the initial values of the reservoir properties may be adjusted, and the fluid and geomechanical calculations can be repeated based on the adjusted values. In some cases, the process of modifying the initial values and using the model equations to calculate the deformation field may be iterated until acceptable values are found, for example, when the calculated deformation field and the measured deformation match within some specified tolerance and/or when some other criteria are met.

At 312, the suitability of the reservoir for carbon dioxide sequestration is determined, for example, based on the analysis of the response data (at 308) and/or based on the reservoir properties identified (at 310). The suitability may be determined before injecting any carbon dioxide into the reservoir. For example, determining the suitability of the reservoir for carbon dioxide sequestration may include predicting the flow path and/or flow pattern the carbon dioxide will follow after injection. In cases where a surrogate or test fluid is injected, the surrogate or test fluid plume may follow similar flow patterns through the subsurface as a carbon dioxide plume would follow. For example, injected air may rise by buoyancy to the underside of caprocks and spread out in patterns that are controlled by the lower viscosity and density relative to the native formation fluid (e.g., formation water). Thus, the injectate plume may indicate the behavior of carbon dioxide without the expense or risk of injecting carbon dioxide. In fact, because air and other test fluids are less dense and/or less viscous than carbon dioxide, the test fluid plume may be viewed as a conservative estimate of the spreading and fingering of carbon dioxide plumes. For example, air plumes are likely to spread and finger to an even greater extent than carbon dioxide. Furthermore, the injectate plume may mimic the pressure perturbations that would be created by a carbon dioxide plume. In some instances, pressures dissipate quickly in a porous system containing air, which, like carbon dioxide, has a low viscosity relative to water. The low viscosity may allow the air to flow more readily, and pressure may be felt throughout the extent of the gas plumes as they rise, spread and finger. Thus, injecting air and/or other test fluids may, in some instances, give a better characterization of the induced pressure effects of a carbon dioxide injection than an injection of water.

In some implementations, determining suitability of the reservoir for carbon dioxide sequestration includes determining whether or not the reservoir can store carbon dioxide. For example, it may be determined that the reservoir is unsuitable because of leaks that would allow the carbon dioxide to quickly escape the reservoir. Determining that a reservoir is suitable for carbon dioxide sequestration may include determining that the reservoir could potentially store a given volume of carbon dioxide for a given amount of time. In some instances, a fast drop in pressure of the injected fluid may indicate a leak in the reservoir. It may be determined that a reservoir is unsuitable because of seismic or other geomechanical activity. Determining that a reservoir is suitable for carbon dioxide sequestration may include determining that the reservoir could potentially receive carbon dioxide injection without inducing or experiencing mechanical activity above a threshold level (e.g., a threshold Richter Scale value). Determining whether a reservoir is suitable for carbon dioxide sequestration may include determining whether the reservoir complies with environmental standards, regulations, laws, or other types of requirements for carbon dioxide sequestration sites.

Determining suitability for sequestration may include, for example, identifying that carbon dioxide can be injected into the reservoir for sequestration in the reservoir without fracturing the formation to a substantial degree, without inducing fault motion, and/or without inducing seismicity. For example, in some cases, injecting fluids in a subsurface formation under high pressures may induce seismicity in the formation and/or may induce creep in the formation, wherein formation rocks slowly move with respect to one another. In some cases, a formation is suitable for sequestration when there is a low likelihood that the fluid injection will induce this type of activity in the formation. In some cases, relatively small amounts of induced seismicity and/or creep may be acceptable and therefore may not render the formation unsuitable for sequestration activities.

In some cases, one or more operations of the example process 300 may be repeated and/or iterated. For example, as indicated by the dashed lines in FIG. 3, after the data analysis at 308 and/or after the reservoir properties are identified at 310, additional fluid may be injected at 304. For example, fluid may be injected at the same location in the same well bore as before, at a different vertical depth in the same well bore, through a different well bore, through multiple additional well bores, and/or any combination of these. For example, various regions and/or properties of the reservoir may be tested and/or analyzed based on multiple fluid injections performed in series and/or parallel.

While this specification contains many specific implementation details, these should not be construed as limitations on the scope of any inventions or of what may be claimed, but rather as descriptions of features of particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single embodiment.

In the present disclosure, “each” refers to each of multiple items or operations in a group, and may include a subset of the items or operations in the group and/or all of the items or operations in the group. In the present disclosure, the term “based on” indicates that an item or operation is based at least in part on one or more other items or operations—and may be based exclusively, partially, primarily, secondarily, directly, or indirectly on the one or more other items or operations.

A number of embodiments of the invention have been described. Nevertheless, it will be understood that various modifications may be made without departing from the spirit and scope of the invention. Accordingly, other embodiments are within the scope of the following claims.

What is claimed is:

1. A method for using a test fluid to determine suitability of a reservoir in a subsurface region for carbon dioxide sequestration, the method comprising:
injecting a test fluid into a reservoir in a subsurface region, the test fluid having at least one of a test fluid density less than a density of carbon dioxide or a test fluid viscosity less than a viscosity of carbon dioxide;
collecting response data associated with the test fluid in the reservoir; and
determining a suitability of the reservoir for carbon dioxide sequestration based on the response data.

2. The method of claim 1, wherein the test fluid comprises air.

3. The method of claim 1, wherein the test fluid comprises flue gas.

4. The method of claim 1, wherein the test fluid has:
a test fluid density less than a density of carbon dioxide; and
a test fluid viscosity less than a viscosity of carbon dioxide.

5. The method of claim 1, further comprising collecting baseline data prior to collecting the response data.

6. The method of claim 1, wherein the response data comprises seismic data, and determining the suitability comprises identifying seismicity induced in the reservoir by the injection of the test fluid.

7. The method of claim 1, wherein collecting response data comprises collecting at least one of seismic data or geodetic data.

8. The method of claim 7, wherein collecting seismic data comprises at least one of:
collecting two-dimensional seismic data at sensors above the subsurface region;
collecting three-dimensional seismic data at sensors above the subsurface region; or
collecting vertical seismic profile data at sensors in the subsurface region.

9. The method of claim 7, wherein collecting seismic data comprises collecting seismic data for generating seismic imagery of the test fluid in the reservoir.

10. The method of claim 7, wherein collecting geodetic data comprises collecting geodetic surface data using at least one of:
a global positioning system (GPS) receiver above the subsurface region;
a satellite interferometric synthetic aperture radar (InSAR);
an aerial InSAR;
a tilt meter about the subsurface region;
a leveling instrument; or
a laser ranging instrument.

11. The method of claim 7, wherein collecting geodetic data comprises collecting geodetic data for determining a topography of a surface above the subsurface region.

12. A method for using a surrogate fluid to determine suitability of a reservoir in a subsurface region for fluid sequestration, the method comprising:
injecting a surrogate fluid into a reservoir in a subsurface region;
collecting response data associated with the surrogate fluid in the reservoir;
determining at least one characteristic of the reservoir based on the response data; and
determining a suitability of the reservoir for sequestration of a fluid for storage based on the at least one characteristic.

13. The method of claim 12, wherein the fluid for storage comprises carbon dioxide, the surrogate fluid comprises substantially no carbon dioxide, and determining the suitability of the reservoir comprises determining the suitability of the reservoir for sequestration of carbon dioxide.

14. The method of claim 12, wherein the fluid for storage comprises natural gas, the surrogate fluid comprises substantially no natural gas, and determining the suitability of the reservoir comprises determining the suitability of the reservoir for sequestration of natural gas.

15. The method of claim 12, wherein determining at least one characteristic of the reservoir comprises determining a location of the surrogate fluid in the reservoir.

16. The method of claim 12, wherein the surrogate fluid comprises native formation fluid.

17. The method of claim 12, wherein collecting response data comprises collecting geodetic surface data, and determining at least one characteristic of the reservoir comprises:
identifying a movement of a surface above the reservoir based on the geodetic surface data; and
determining the at least one characteristic of the reservoir based on the movement of the surface.

18. The method of claim 12, wherein collecting response data comprises collecting seismic imagery data of the surrogate fluid in the reservoir, and determining at least one characteristic of the reservoir comprises:
identifying a movement of the surrogate fluid in the subsurface region based on the seismic imagery data; and
determining at least one characteristic of the reservoir based on the movement of the surrogate fluid.

19. The method of claim 12, wherein the at least one characteristic includes at least one of hydrogeologic properties of the reservoir or geomechanical properties of the reservoir.

20. The method of claim 19, wherein the hydrogeologic properties include at least one of a permeability of at least a portion of the reservoir or a conductivity field for at least a portion of the reservoir, and the geomechanical properties include at least one of fractures in the reservoir, boundaries of the reservoir, compressibility, or state of stress.

21. A method comprising:
injecting a fluid into a reservoir in a subsurface region;
collecting three-dimensional geodetic data associated with a surface above the subsurface region;
identifying a three-dimensional geodetic response to the fluid in the reservoir based on the three-dimensional geodetic data; and
determining at least one characteristic of the reservoir based on the three-dimensional geodetic response.

22. The method of claim 21, wherein collecting the three-dimensional geodetic data comprises collecting data using at least one of a global positioning system or an interferometric synthetic aperture radar system.

23. The method of claim 21, wherein identifying a three-dimensional geodetic response to the fluid in the reservoir comprises determining a deformation of the surface based on the three-dimensional geodetic data, wherein determining at least one characteristic comprises determining the at least one characteristic based on the deformation.

24. The method of claim 21, wherein the fluid comprises primarily carbon dioxide.

25. The method of claim 21, wherein the fluid comprises a surrogate for carbon dioxide.

26. The method of claim 21, the fluid having at least one of a fluid density less than a density of carbon dioxide or a fluid viscosity less than a viscosity of carbon dioxide.

27. The method of claim 26, further comprising determining a suitability of the reservoir for carbon dioxide sequestration based on the at least one characteristic prior to injecting carbon dioxide into the reservoir.

28. The method of claim 21, wherein determining at least one characteristic of the reservoir comprises monitoring the at least one characteristic while injecting carbon dioxide into the reservoir.

29. The method of claim 21, wherein determining at least one characteristic of the reservoir comprises monitoring the at least one characteristic after injecting carbon dioxide into the reservoir.
